(19) United States
(12) Patent Application Publication
(10) Pub. No.: US 2009/0237388 A1
(43) Pub. Date: Sep. 24, 2009

(54) DISPLAY TERMINAL AND COMPUTER-READABLE RECORDING MEDIUM RECORDING DISPLAY TERMINAL PROGRAM

(75) Inventor: Mariko Seki, Nagoya-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya-shi (JP)

(21) Appl. No.: 12/405,084

(22) Filed: Mar. 16, 2009

(30) Foreign Application Priority Data
Mar. 19, 2008 (JP) 2008-071563

(51) Int. Cl. G09G 5/00

(52) U.S. Cl. 345/211

(57) ABSTRACT

A display terminal including a nonvolatile display device that retains display of information even if power supply is cut off, a battery that supplies power to the nonvolatile display device, a display control device that causes the nonvolatile display device to display charging prospective information serving as a prospect of charging the battery, at a predetermined timing, and a power cutoff control device that cuts off supply of power from the battery to the nonvolatile display device while causing the nonvolatile display device to retain the display of the charging prospective information.

### CROSS-REFERENCE TO RELATED APPLICATION

The present application claims priority from Japanese Patent Application No. 2008-071563, which was filed on Mar. 19, 2008, the disclosure of which is hereby incorporated by reference in its entirety.

### BACKGROUND OF THE INVENTION

The present disclosure relates to a display terminal and a computer-readable recording medium recording a display terminal program. More specifically, the present disclosure relates to a display terminal and a computer-readable recording medium recording a display terminal program that can prevent a user from getting confused about a remaining battery level that decreases as the display terminal consumes battery power.

Conventionally, a view terminal has been known which is equipped with a rechargeable system power supply in it and employs a nonvolatile display device utilizing electrophoresis (see, for example, Japanese Patent Application Laid-Open No. 2007-187927). A view terminal, such as that described in Japanese Patent Application Laid-Open No. 2007-187927, employs a nonvolatile display device and, therefore, will retain contents displayed on the display device most recently even in a condition where the system power supply is cut off. Further, some of the typical view terminals may display a remaining battery level on a display screen.

### SUMMARY OF THE INVENTION

However, in a view terminal, such as that described in Japanese Patent Application Laid-Open No. 2007-187927, a stored power in the battery will be discharged even in a condition where the system power supply is turned off. As time goes by with the system power supply turned off, the accumulated power may be discharged completely. In such a case, the most recently displayed contents are indicated on the display device, so that the user might not think the terminal has run out of power. As a result, such a problem may occur that the user will find the view terminal is short of power only after the user tries to use it. Further, in a display terminal equipped with a nonvolatile display device, like the view terminal described in Japanese Patent Application Laid-Open No. 2007-187927, in a case where a remaining battery level is indicated on the nonvolatile display device, as the battery is discharged during the passage of time in a condition where the system power supply is turned off, a difference may occur between a remaining battery level indicated on the display device and an actual level thereof. As a result, a problem may occur that, by watching the display of the view terminal, the user would think the battery has a power, however the actual power in the battery is no or little, so the view terminal cannot work or runs short of power soon after the user starts using the view terminal.

To solve these problems, the present disclosure has been developed, and it is an object of the present disclosure to provide a display terminal and display terminal program that can prevent a user from getting confused by a remaining battery level that decreases as the display terminal consumes battery power.

To this end, a first aspect of the present disclosure provides a display terminal comprising a nonvolatile display device that retains information display even if power supply is cut off, a battery that supplies power to the nonvolatile display device, a display control device that causes the nonvolatile display device to display charging prospective information serving as a prospect of charging the battery, at a predetermined timing, and a power cutoff control device that cuts off supply of power from the battery to the nonvolatile display device while causing the nonvolatile display device to retain the display of the charging prospective information.

A second aspect of the present disclosure provides a display terminal program recorded in a computer-readable recording medium, which causes a computer to function as various processing devices for the above-described display terminal.

Other objects, features, and advantage will be apparent to persons of ordinary skill in the art from the following detailed description of the invention and the accompanying drawings.

### BRIEF DESCRIPTION OF THE DRAWINGS

For a more complete understanding of the present invention, the needs satisfied thereby, and the features and technical advantages thereof, reference now is made to the following descriptions taken in connection with the accompanying drawings.

FIG. 1 is an external view of a display terminal;

FIG. 2 is a block diagram showing an electrical configuration of the display terminal;

FIG. 3 is a front view of an electrophoretic display portion;

FIG. 4 is a cross-sectional view taken along line I-I (FIG. 3) of the electrophoretic display portion as viewed in an arrow direction;

FIG. 5 is a cross-sectional view taken along line II-II (FIG. 3) of the electrophoretic display portion as viewed in the arrow direction;

FIG. 6 is a flowchart of event waiting processing during a main operation;

FIG. 7 is a flowchart in a case where power supply is cut off during the main operation;

FIG. 8 is an external view of a display terminal that displays a date when a last event occurred;

FIG. 9 is a schematic view of a charging date table;

FIG. 10 is a flowchart of a modification in a case where power supply is cut off during the main operation;

FIG. 11 is a flowchart of a modification in a standby state;

FIG. 12 is a flowchart of a modification in a case where power supply is cut off during the main operation; and

FIG. 13 is an external view of the display terminal on which a charging message is displayed.

### DETAILED DESCRIPTION OF THE EXEMPLARY EMBODIMENTS

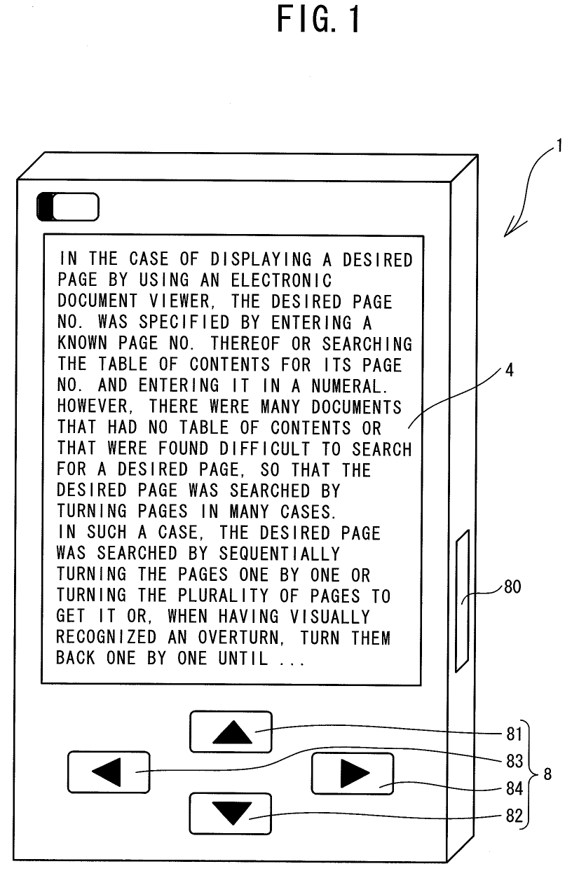

Embodiments of the present invention and their features and technical advantages may be understood by referring to FIGS. 1-13, like numerals being used for like corresponding portions in the various drawings.

A display terminal 1 according to first embodiment of the present disclosure will be described with reference to FIGS. 1 to 8. The display terminal 1 of the present embodiment is equipped with an electrophoretic display portion that retains displayed contents even if its power supply is cut off.

First, the external view of the display terminal 1 will be described with reference to FIG. 1. As shown in FIG. 1, the display terminal 1 is roughly rectangular solid-shaped. The display terminal 1 comprises an electrophoretic display portion 4 on its front surface in front view. Below the electrophoretic display portion 4, the display terminal 1 comprises an operation key 8 including an up key 81, a down key 82, a left key 83, and a right key 84. The display terminal 1 has a loading slot 80 provided on its right side surface into which a memory card 17 is inserted.

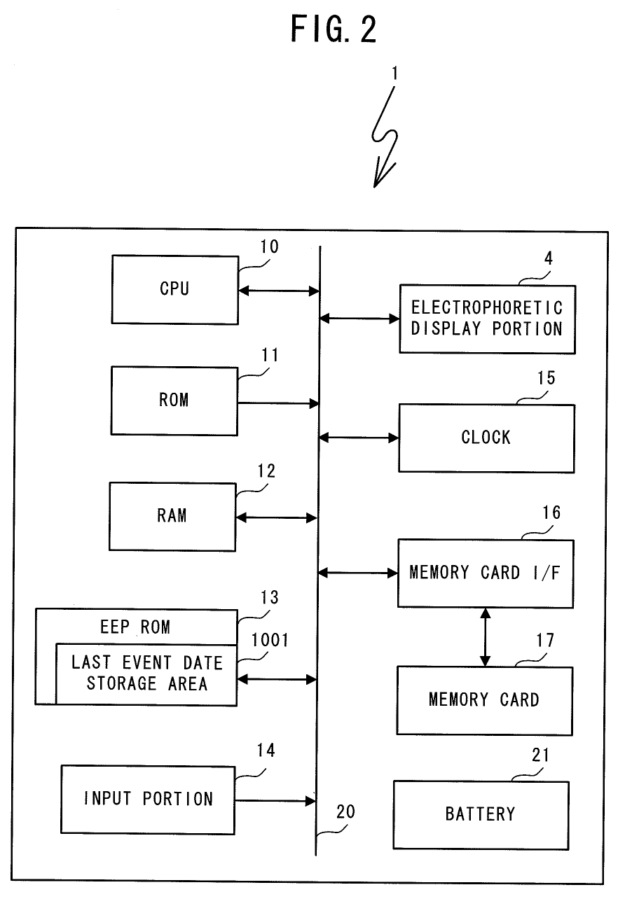

Next, the electrical configuration of the display terminal 1 will be described with reference to a block diagram of FIG. 2. As shown in FIG. 2, the display terminal 1 comprises a CPU 10 to control the display terminal 1. The CPU 10 is connected via a bus 20 to a ROM 11, a RAM 12, an EEPROM 13, an input portion 14, an electrophoretic display portion 4, a clock 15, and a memory card I/F 16. The ROM 11 stores beforehand a program, etc. to operate the display terminal 1. The RAM 12 stores various kinds of data temporarily. The EEPROM 13 is a nonvolatile memory. The input portion 14 includes buttons to accept the entry by the user and arrow keys. The electrophoretic display portion 4 displays contents. The clock 15 measures time. The memory card I/F 16 connects the memory card 17 to the display terminal 1. The memory card 17 stores contents information, which comprises characters, images, pictures, or a combination thereof. The display terminal 1 has a built-in battery 21. The battery 21 supplies power to the electrical circuits in the display terminal 1 such as the CPU 10 and the electrophoretic display portion 4.

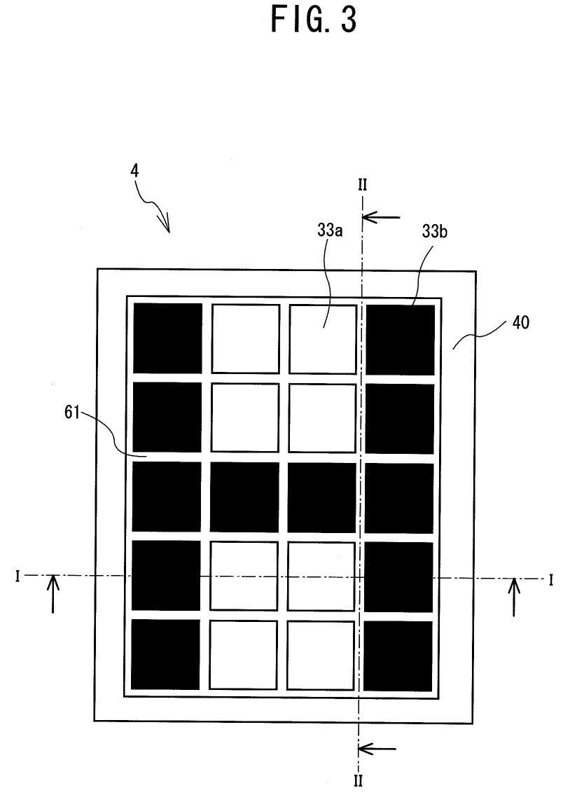

Now, an outline of the physical configuration of the electrophoretic display portion 4 will be described with reference to the drawings. As shown in FIGS. 3 to 5, the electrophoretic display portion 4 comprises a lower substrate 50, an upper substrate 60, and a display portion 70. The lower substrate 50 is mounted on the back side of the electrophoretic display portion 4. The upper substrate 60 is mounted on the front side of the electrophoretic display portion 4 in a condition where it faces the lower substrate 50. The display portion 70 is provided between the lower substrate 50 and the upper substrate 60. Line I-I indicates a cross-sectional line parallel to the horizontal direction (right-and-left direction in FIG. 1) of the display terminal 1 and line II-II indicates a cross-sectional line parallel to the vertical direction (up-and-down direction in FIG. 1) of the display terminal 1. In FIGS. 3 to 5, for ease of explanation, the number of pixels is assumed to be 20 (=5×4); however, actually, that number may be any value as required.

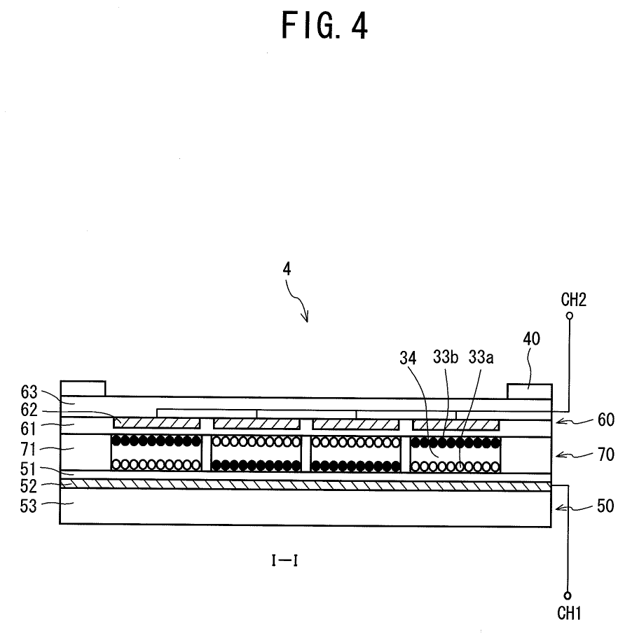

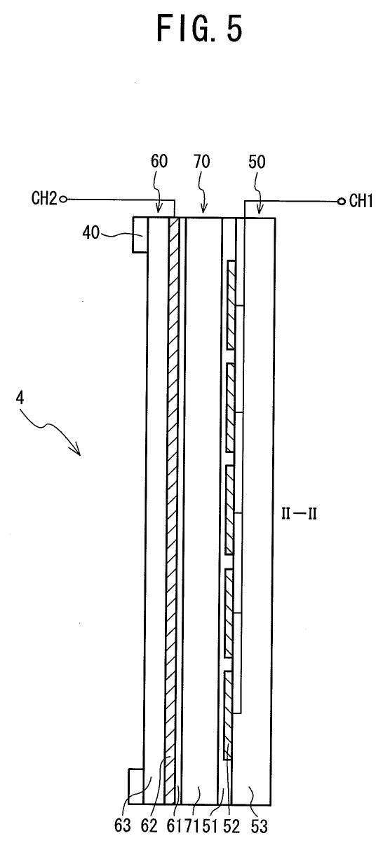

As shown in FIGS. 4 and 5, the lower substrate 50 comprises a lower electrode protection film 51, a lower electrode 52, and a case support portion 53. The lower electrode 52 generates an electric field to the display portion 70. The lower electrode protection film 51 is an insulating film formed by, for example, applying an insulating material on the upper side surface of the lower electrode 52. The case support portion 53 is mounted on the back side of the lower electrode 52, to support the electrophoretic display portion 4. The lower electrode protection film 51 is made of a material that can give a high degree of insulation, such as an inorganic substance including glass and resin film such as polyethylene terephthalate or silica. Note that in the present embodiment, the lower electrode protection film 51 and the case support portion 53 are formed of a plastic substrate (resin film) made of flexible polyethylene terephthalate. Further, the lower electrode 52 is a substrate that includes a plurality of electrodes with linear electrically conductive materials disposed parallel to each other horizontally (in the direction of line I-I) so that a constant voltage may be applied on them.

In the upward direction of the lower substrate 50 (upward direction in FIG. 3), the upper substrate 60 is mounted in a condition where it faces parallel to the lower substrate 50 with predetermined horizontal spacing between them. The upper substrate 60 comprises an upper electrode 62, an upper electrode protection film 61, and a display layer 63. The upper electrode 62 generates an electric field to the display portion 70. The upper electrode protection film 61 is an insulating film formed, for example, by applying an insulating material on the back side surface of the upper electrode 62. The display layer 63 is formed of a transparent member and mounted on the front side surface of the upper electrode 62, thus functioning as a display screen. The upper electrode protection film 61 is made of a material that can give a high degree of transparency, such as polyimide, polyethylene terephthalate, or glass. The upper electrode 62, which is made of a material that can give a high degree of transparency, is a substrate that includes a plurality of electrodes with linear electrically conductive materials disposed parallel to each other vertically in the direction of line II-II so that a constant voltage may be applied on them. In the present embodiment, the upper electrode protection film 61 is a plastic substrate (resin film) made of polyethylene terephthalate. The upper electrode 62 is a transparent electrode made of indium tin oxide (ITO) and the display layer 63 is formed of a glass substrate. That is, the upper substrate 60 is transparent and, therefore, acts as such a display substrate that the user can visually recognize the display portion 70 through the upper substrate 60 downward (from the upper side in FIG. 4).

Next, the display portion 70 will be described. The display portion 70 is realized by a gap that is formed by the lower substrate 50 and the upper substrate 60 mutually facing and a spacer 71. The spacer 71 is provided in the gap between the lower substrate 50 and the upper substrate 60. The spacer 71 evenly divides the gap into a plurality of partitioned small cells in a lattice arrangement and also supports the lower substrate 50 and the upper substrate 60. The spacer 71 is a flexible member configured as a plate-like member in which a plurality of through holes are formed in a lattice arrangement and only needs to be made of synthetic resin such as polyimide or polyethylene terephthalate, for example.

As shown in FIG. 4, the gap formed by the lower substrate 50 and the upper substrate 60, and the spacer 71 is filled with charged particles 33a and 33b as well as a dispersed medium 34. The charged particles 33a and 33b are each made of a material that can be charged in the dispersed medium 34. Specifically, the material of the charged particles 33a and 33b may be pigment or dye which is made of an organic or inorganic compound or those packed by synthetic resin. In the present embodiment, the charged particles 33a may employ a mixture of styrene resin and titanium dioxide. The charged particles 33a each have an average particle diameter of 5 μm (7 weight percent) and contain 40 weight percent of titanium dioxide. On the other hand, the charged particles 33b may employ a mixture of styrene resin and carbon black. The charged particles 33b each have an average particle diameter of 5 μm (10 weight percent) and contain 30 weight percent of carbon black. Accordingly, the charged particles 33a have the color tone of white and the charged particles 33b have the color tone of black. The particles 33a and the particles 33b are charged positively and negatively or vice versa oppositely. In the present embodiment, it is assumed that the particles 33a are charged negatively and the particles 33b are charged positively.

Also, the dispersed medium 34 may employ alcohols, carbon hydride, and silicone oil, which can give a high degree of insulation and have a low viscosity. The present embodiment has employed Isopar (73 weight percent) made by Exxon Mobil Corporation, which is a paraffin-based solvent, for the dispersed medium 34. Note that ethanol (10 weight percent) is added to the dispersed medium 34 as an additive agent.

A mask portion 40 is mounted on the upper surface (which does not face the lower substrate 50) of the upper substrate 60. The mask portion 40 prevents the user from visually recognizing the peripheral borders of the display portion 70 where the partitioned small cells are not present, in front view. The mask portion 40 is a member that forms a sheet-shaped square frame. The mask portion 40 may be formed by attaching colored synthetic resin such as polyethylene terephthalate or forming by an ink layer printed onto the surface of the display layer 63. If the user look down the electrophoretic display portion 4 provided with the mask portion 40, the user will see that the four sides of the upper substrate 60 are hidden by the frame portion of the mask portion 40 by a constant width, while permitting the user to visually recognize the display portion 70 through the through holes formed in the mask portion 40.

Next, a storage area arranged in the EEPROM 13 will be described with reference to FIG. 2. The EEPROM 13 has a last event date storage area 1001 arranged therein. The last event date storage area 1001 stores a time when a user operation such as a key entry or an external access (hereinafter referred to as an “event”) occurred is acquired from the clock 15. The time stored in the last event date storage area 1001 can be rewritten, so that only a time when the last event occurred is stored in it.

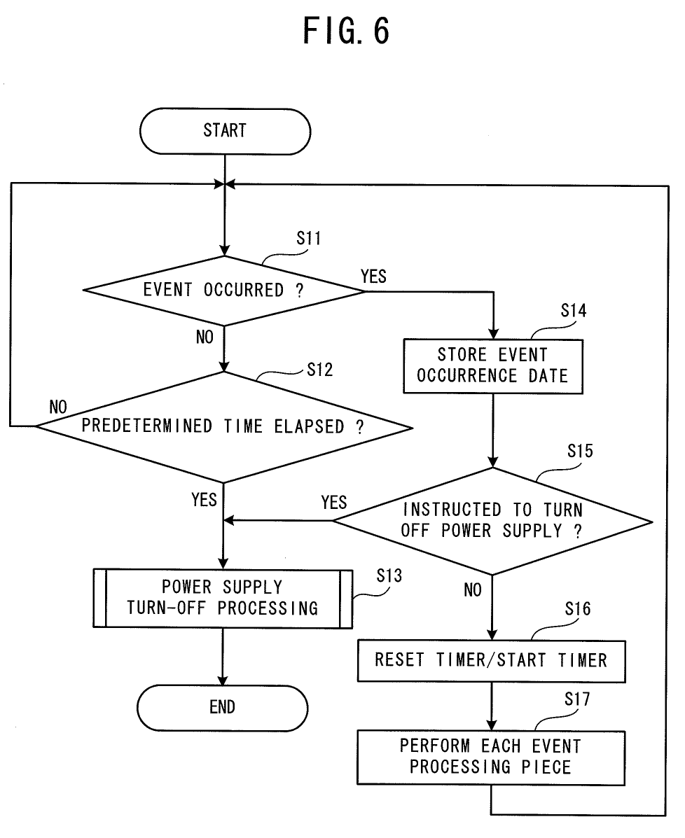

Next, the operations of event waiting processing of the display terminal 1 will be described with reference to FIG. 6. The present operations start when a power supply for the display terminal 1 is turned on to start supply of power from the battery 21 thereto. First, a description will be given of the operations to be performed in a case where power is supplied from the battery 21 to the display terminal 1 and then an event has occurred. When power is supplied from the battery 21 to the display terminal 1, a determination is made as to whether an event has occurred (S11). That is, a determination is made as to whether an operation such as a key entry is made by the user or an access is occurred from the outside. If an event occurred (YES at S11), the clock 15 (see FIG. 2) acquires a time on which the event occurred. The occurrence time of the event is stored in the last event date storage area 1001 (see FIG. 2) of the EEPROM 13 (see FIG. 2) (S14). Then, a determination is made as to whether this event is of power supply turn-off processing for the display terminal 1 (S15). If this event is of the power supply turn-off processing for the display terminal 1, the power supply for the display terminal 1 is turned off, to also cut off supply of power from the battery 21 to the electrophoretic display portion 4.

On the other hand, if the event is not of the power supply turn-off processing for the display terminal 1 (NO at S15), the counter value of a timer in a waiting time counter is initialized to “0” and the timer start processing is stared to perform the measurement of time (S16). The waiting time counter is a timer counter to measures a lapse of time that has elapsed until the next event occurs, that is, a lapse of time during which no event has occurred. The waiting time counter is incremented based on a signal from the clock 15 connected to the CPU 10. Next, processing is performed based on the event that has occurred at S11 (S17), and the processing returns to S11. In such a manner, if the event that has occurred at S11 is not of the power supply turn-off processing for the display terminal 1, the processing (YES at S11→NO at S14 and S15→S16 ( S17) is repeated.

As described above, if an event that has occurred is not of the power supply turn-off processing for the display terminal 1, an occurrence time of the event is acquired and stored in the last event date storage area 1001 in the EEPROM 13. Then, the counter value of the timer is initialized to “0” and the timer start processing is stared to perform the measurement of a lapse of time during which no event has occurred. Then, the processing based on the event occurred is performed. That is, each time an event occurs, its occurrence time is stored in the last event date storage area 1001 (see FIG. 2).

Next, a description will be given of the operations to be performed in a case where an event that has occurred is of the power supply turn-off processing for the display terminal 1 caused by a key entry. If a key is entered by the user and an event occurs (YES at S11), an occurrence time of the key entry is stored (S14). Then, a determination is made as to whether the key entry is of the power supply turn-off processing for the display terminal 1 (S15). The key entry is of the power supply turn-off processing for the display terminal 1 (YES at S15), so that the power supply turn-off processing is performed (S13). In such a manner, when the operation is performed to turn off the power supply for the display terminal 1 through a key entry, a time when the power supply is turned off is acquired and stored in the last event date storage area 1001 in the EEPROM 13. Then, the power supply turn-off processing is performed (S13). The power supply turn-off processing will be described later.

Next, a description will be given of the operations to be performed in a case where no event has occurred in a predetermined lapse of time so that the power supply for the display terminal 1 may be turned off. Note that the predetermined lapse of time only needs to be long enough to determine that the user is not operating the display terminal 1, and is defined beforehand. In the present embodiment, the predetermined lapse of time is assumed to be five seconds. If no event has occurred (NO at S11), a determination is made as to whether the value of the waiting time counter is at least the predetermined lapse of time. If no event has occurred and the waiting time counter is less than the predetermined lapse of time (NO at S12), it will not be determined that no event has occurred for more than the predetermined lapse of time, so that the processing returns to S11 to make a determination as to whether an event has occurred. In such a manner, unless an event occurs, this processing (NO at S11 ( NO at S12) is repeated until the predetermined lapse of time elapses. If no event occurs until the predetermined lapse of time elapses (YES at S12), the power supply turn-off processing for the display terminal 1 (S13) is performed. The power supply turn-off processing (S1 3) will be described later.

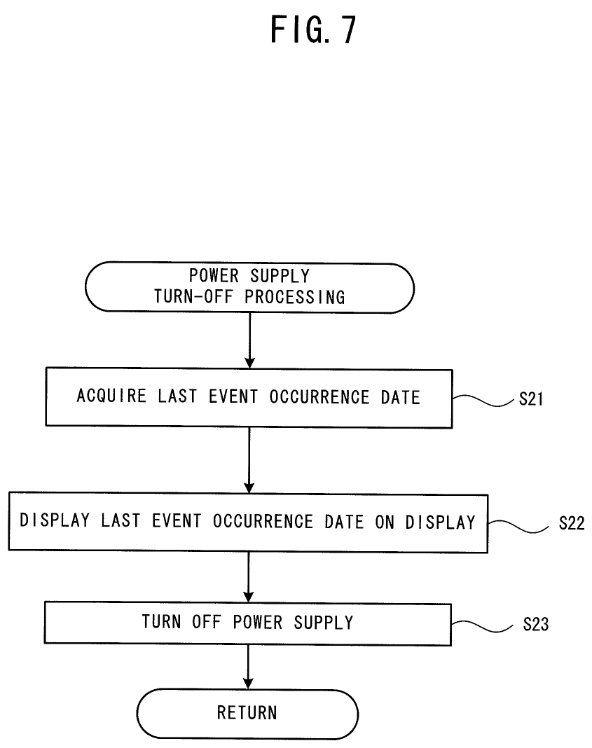

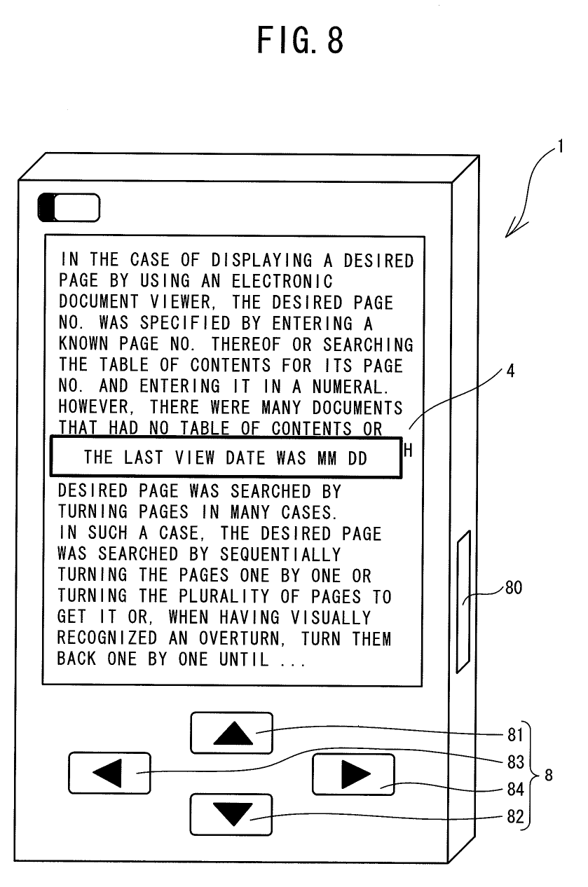

Next, operations of the power supply turn-off processing will be described with reference to FIGS. 6 to 8. These operations are of processing which is started when the power supply for the display terminal 1 is turned off. When the power supply turn-off processing (S13 in FIG. 6) is performed, a time stored in the last event date storage area 1001 in the EEPROM 13 is read out(S21 in FIG. 7) and displayed on the electrophoretic display portion 4 of the display terminal 1 (S22). Then, the power supply for the display terminal 1 is turned off (S23). Note that as shown in FIG. 8, the data of the occurrence of the last event displayed on the display terminal 1 is displayed roughly at the midsection of the electrophoretic display portion 4. Note that the last event occurrence time displayed on the electrophoretic display portion 4 is retained in a condition where it is displayed, even if the power supply for the display terminal 1 is turned off.

In such a manner, in the display terminal 1 of this embodiment, a time when an event has occurred is acquired from the clock 15 and stored in the last event date storage area 1001 arranged in the EEPROM 13. Then, before the power supply for the display terminal 1 is turned off, the last event occurrence time is read out from the last event date storage area 1001 and displayed on the electrophoretic display portion 4. Since the contents displayed on the electrophoretic display portion 4 are retained in a condition where they are displayed even if the power supply for the display terminal 1 is turned off, the user trying to use the display terminal 1 next time can confirm the time when the last event occurred, that is, the time when it is used last time. Thus, the user can make a determination as to whether to charge the battery, taking into account of discharge of battery since the last time it is used. If the user determines that the display terminal 1 needs to be charged, the user can charge it. Therefore, such a problem can be prevented from occurring that the user trying to use the display terminal 1 may find that it has no sufficient power and cannot be used or it runs short of power soon after the user starts using it.

Note that the display terminal 1 of the present disclosure is not limited to the described embodiment and, of course, can be modified variously without departing the gist of the present disclosure. Although in the embodiment, the clock 15 measuring the time is provided inside the display terminal 1, it may be mounted outside the display terminal 1 so that the time might be acquired as required.

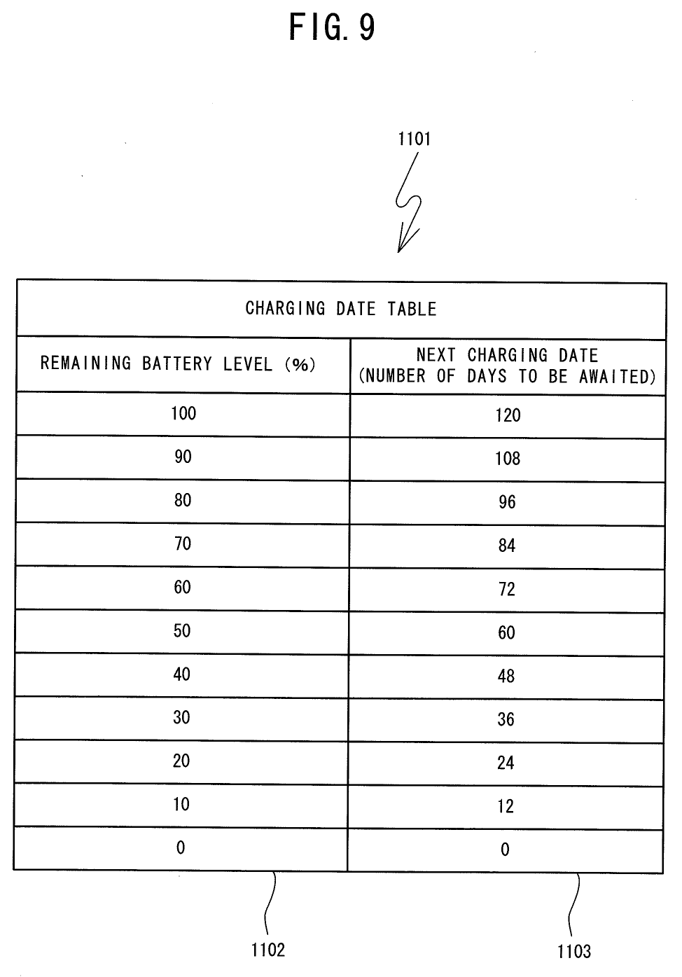

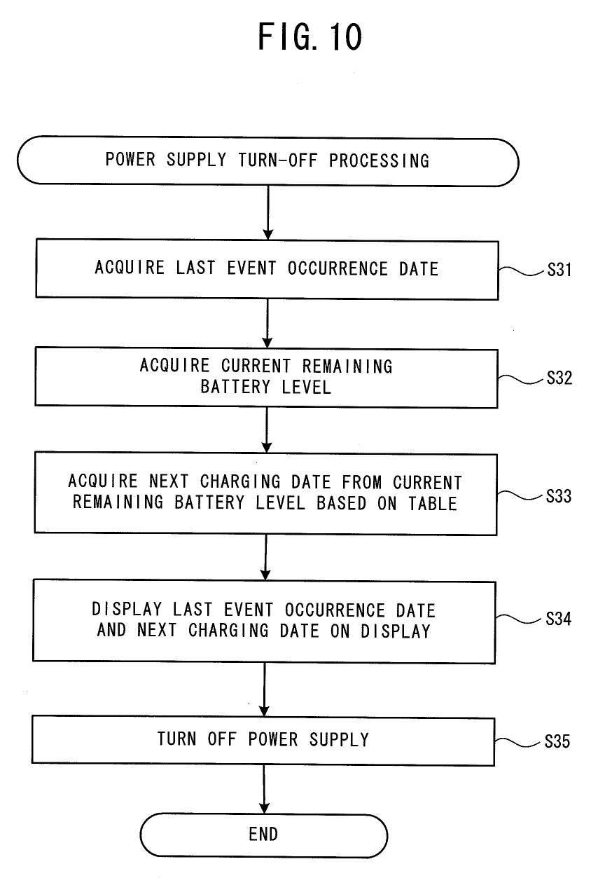

Although in the embodiment above, the time of the last event is displayed on the electrophoretic display portion 4, the displayed contents are not limited to it. For example, a prospective date of the next charging (hereinafter referred to as a “next charging date”) may be displayed on the electrophoretic display portion 4. A description will be given of operations of displaying a next charging date when the power supply for the display terminal 1 is turned off as modification 1 with reference to FIGS. 9 and 10.

First, the electrical configuration of modification 1 will be described. The electrical configuration of modification 1 is the same as that of the embodiment except for a charging date table storage area (not shown) arranged in the ROM 11. The charging date table storage area (not shown) stores beforehand a charging date table 1101 (see FIG. 9) in which next charging dates are set.

Next, the configuration of the charging date table 1101 stored beforehand in the charging date table storage area (not shown) in the ROM 11 will be described with reference to FIG. 9. As shown in FIG. 9, the charging date table 1101 comprises a storage region 1102 to store a remaining battery level of the display terminal 1 and a storage region 1103 to store a next charging date based on the remaining battery level. In the storage region 1102, the remaining battery level range is subdivided into 10-percent segments including a 0-percent segment that indicates no power being left in the battery 21 through a 100-percent segment that indicates the fully charged state of the battery 21 of the display terminal 1. The next charging dates in storage region 1103 is stored in a condition where they correspond to these subdivided remaining battery levels respectively.

Next, a description will be given of operations performed when the power supply turn-off processing is performed in modification 1 with reference to FIGS. 6 and 10. These operations are of processing which is started when the power supply for the display terminal 1 is turned off. When the power supply turn-off processing (S13 in FIG. 6) is performed, a last event occurrence time is acquired (S31 in FIG. 10). The last event occurrence time refers to a time when the event that occurred last is accepted, and is stored in the last event date storage area 1001 in the EEPROM 13. Then, a remaining battery level of the battery 21 in the display terminal 1 is acquired (S32). The acquired remaining battery level is handled as calculated in percentage assuming the state of no power being left in the battery 21 to be 0% and the fully charged state of the battery 21 to be 100% of the display terminal 1. Note that in this calculation, the first digit values of the percentage of the acquired remaining battery level are truncated. Based on the acquired remaining battery level, a next charging date is acquired from the charging date table 1101 stored in the charging date table storage area (not shown) in the ROM 11 (S33). Next, the acquired next charging date and last event occurrence time are displayed on the electrophoretic display portion 4 of the display terminal 1 (S34). Then, the power supply for the display terminal 1 is turned off (S35). Note that the next charging date and the last event occurrence time displayed on the electrophoretic display portion 4 are retained even if the power supply for the display terminal 1 is turned off.

In such a manner, when the power supply for the display terminal 1 is turned off, a next charging prospective date for charging next time is read out based on the current remaining battery level from the charging date table storage area (not shown) in the ROM 11 and displayed on the electrophoretic display portion 4. Since the contents displayed on the electrophoretic display portion 4 are retained even if the power supply for the display terminal 1 is turned off, the user trying to use the display terminal 1 next time can know a time for charging based on the next charging date displayed on the electrophoretic display portion 4 without a need to predict the charging time. Therefore, the user can determine whether to charge, based on the next charging date displayed on the electrophoretic display portion 4. If then the user determines that the display terminal 1 needs to be charged, the user can charge the display terminal 1. Accordingly, such a problem can be prevented from occurring that the user trying to use the display terminal 1 may find that it has no sufficient power and cannot be used or it runs short of power soon after the user starts using it.

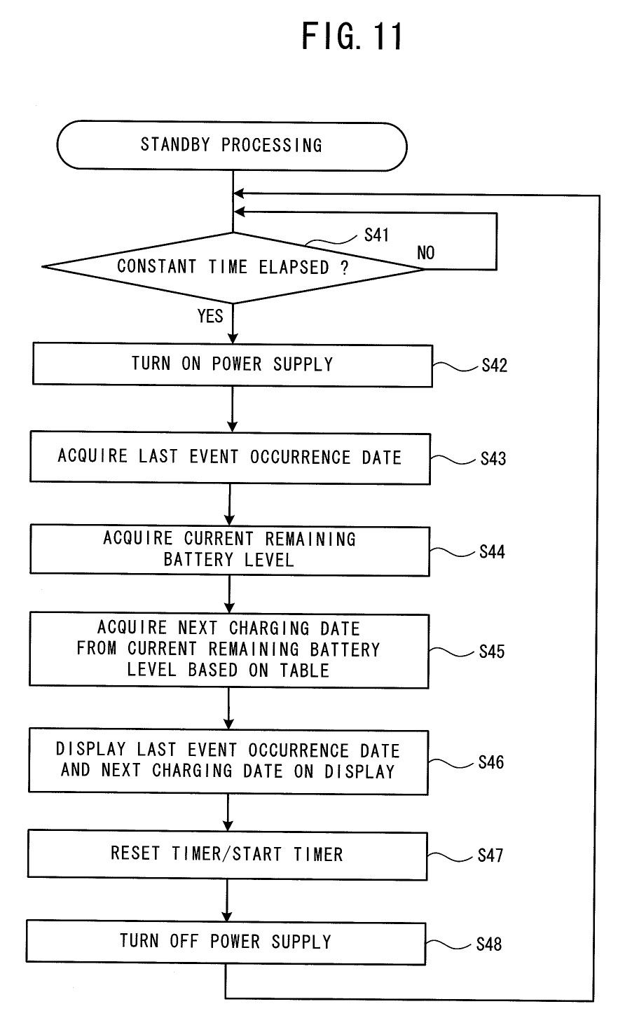

Further, although the above embodiment is displayed an occurrence time of the last event as the last entry date on the electrophoretic display portion 4 when power supply to the display terminal 1 is cut off, the timing for display on the electrophoretic display portion 4 is not limited to it. For example, the display terminal 1 may be started up each time the constant lapse of time (for example, 24 hours) elapses in a standby state in which the supply of power from the battery 21 is suppressed, to display the next charging date as a prospect of next charging on the electrophoretic display portion 4. As modification 2, operations to display a next charging date each time the constant lapse of time elapses in the standby state will be described with reference to FIG. 11.

Next, the operations in the standby state in modification 2 will be described with reference to FIG. 11. These operations are of processing to be started after the power supply for the display terminal 1 is turned off in a condition where the next charging date is displayed on the electrophoretic display portion 4. It is here assumed that, even if the power supply for the display terminal 1 is turned off, the supply of power to the electrical circuits may not totally cut off but the supply of minimum power required to keep the functions of the timer counter etc. may be continued. If a next charging date is displayed when the power supply for the display terminal 1 is turned off, timer start processing is performed by a constant time lapse counter. The constant time lapse counter is a timer counter to measure a constant lapse of time that elapses until the next charging date is displayed. The constant time lapse counter is incremented based on the signal from the clock 15 connected to the CPU 10. When the power supply for the display terminal 1 is turned off, the next charging date is displayed, to reset the value of the constant time lapse counter to “0” so that it may start to be incremented.

Then, a determination is made as to whether a constant lapse of time has elapsed in the standby state (S41). The constant lapse of time has not elapsed immediately after the power supply for the display terminal 1 was turned off (NO at S41), so that the processing returns to S41. Then, this processing is repeated until the constant lapse of time elapses.

When then the timer counter of the constant time lapse counter reaches the constant lapse of time (YES at S41), the power supply for the display terminal 1 is turned on (S42), to read out a last event occurrence time from the last event date storage area 1001 in the EEPROM 13 (S43). The last event occurrence time refers to a time when the event that occurred last was accepted, and is stored in the last event date storage area 1001 in the EEPROM 13. Then, a remaining battery level of the battery 21 in the display terminal 1 is acquired (S44). The acquired remaining battery level is handled as calculated in percentage assuming the state of no power being left in the battery 21 to be 0% and the fully charged state of the battery 21 to be 100% of the display terminal 1. Note that in this calculation, the first digit values of the percentage of the acquired remaining battery level are truncated. Based on the acquired remaining battery level, a next charging date is acquired from the charging date table 1101 stored in the charging date table storage area (not shown) in the ROM 11 (S45). Next, the acquired last entry date and next charging date are displayed on the electrophoretic display portion 4 of the display terminal 1 (S46). Then, the value of the constant time lapse counter is reset to “0” and the constant time lapse counter starts the incrementing thereof (S47). Then, the power supply for the display terminal 1 is turned off (S48), so that the processing returns to S41. In such a manner, the processing (YES at S41 ( S42 to S48) is repeated each time the constant lapse of time elapses, to display the next charging date based on the current remaining battery level on the electrophoretic display portion 4.

In such a manner, when the power supply for the display terminal 1 is turned off, the next charging date that serves as a prospect of next charging is acquired based on the remaining battery level of the battery 21. Then, if the next charging date is displayed on the electrophoretic display portion 4, the constant time lapse counter starts to be incremented so that the display terminal 1 enters the standby state. If the constant time lapse counter reaches at least the constant lapse of time in the standby state, the power supply for the display terminal 1 is turned on. Then, the last event occurrence data on which the last event occurred is read out from the last event date storage area 1001 in the EEPROM 13. Further, based on the current level of the remaining battery level that decreased by discharge during the elapsing of the constant lapse of time, the next charging date is acquired from the charging date table 1101 stored in the charging date table storage area (not shown) in the ROM 11 and displayed together with the last event occurrence time on the electrophoretic display portion 4. If the last event occurrence time and the next charging date are displayed on the electrophoretic display portion 4, the value of the timer counter is reset to “0” and the constant time lapse counter starts incrementing of counter again. Then, the power supply for the display terminal 1 is turned off, to enter the display terminal 1 in the standby state. The processing is repeated until the user uses the display terminal 1 next time.

In such a manner, even when the user is not using the display terminal 1, the next charging date is displayed on the electrophoretic display portion 4 of the display terminal 1 each time the constant lapse of time elapses. As a result, the user trying to use the display terminal 1 next time is notified of a next charging date more accurate than that at the time when power supply was cut off most recently, taking into account a remaining battery level that is decreased by the discharge since the last time of power supply cutoff. Therefore, the user can know a more practical next charging date based on the most recent next charging date displayed on the electrophoretic display portion 4 and make a determination as to whether to charge the display terminal 1 based on this more practical date before using the display terminal 1. If then the user determines the display terminal 1 needs to be charged, the user can charge the display terminal 1. Therefore, such a problem can be prevented from occurring that the user trying to use the display terminal 1 may find that it has no sufficient power and cannot be used or it runs short of power soon after the user starts using it.

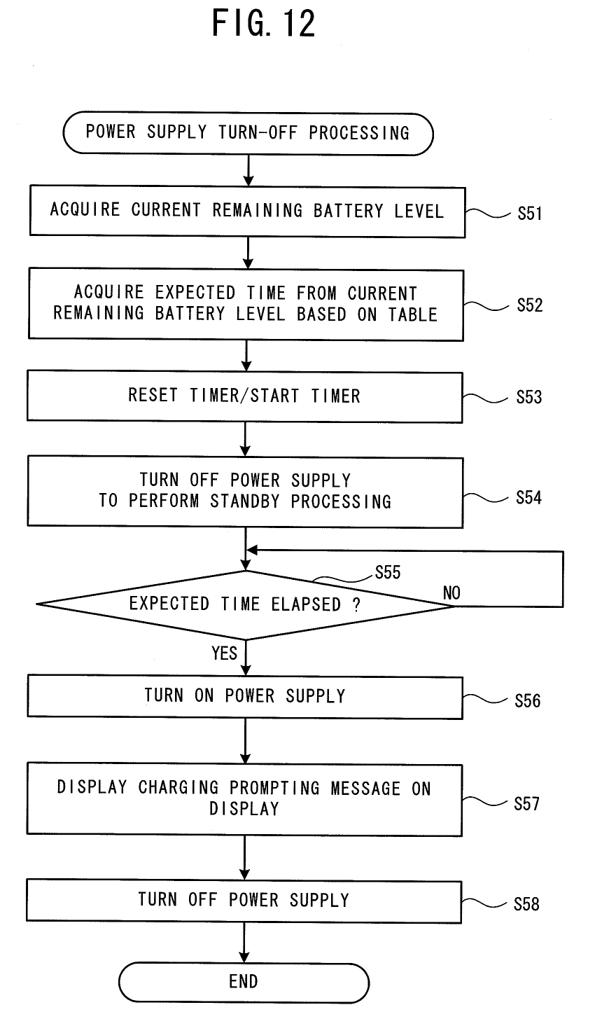

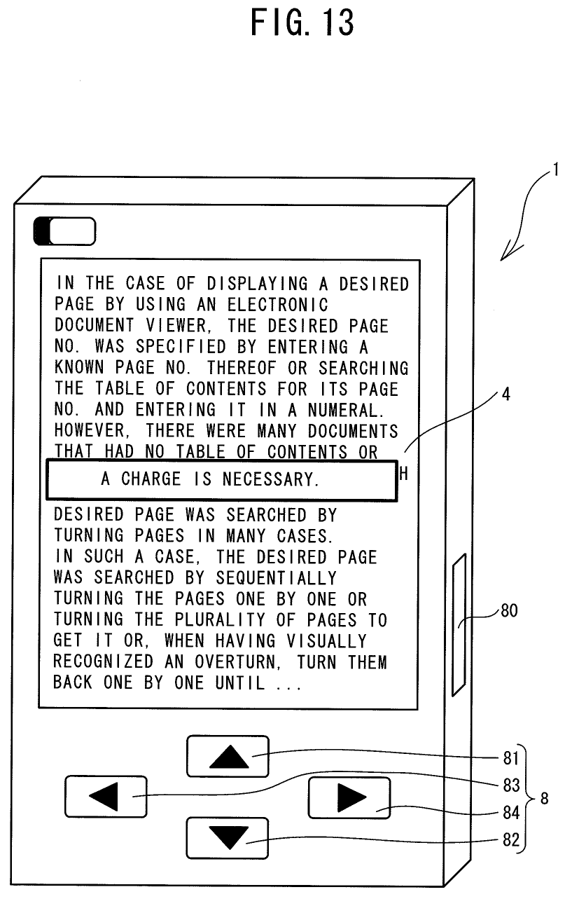

Further, in the above embodiment, an occurrence time of the last event as the last entry date is displayed on the electrophoretic display portion 4 when power supply to the display terminal 1 is cut off. However, the timing and contents for display on the electrophoretic display portion 4 are not limited to them. For example, a message (hereinafter referred to as a “charging message”) may be displayed which prompts charging on the electrophoretic display portion 4 by starting up the display terminal 1 after an expected lapse of time elapses in the standby state in which the supply of power from the battery 21 is suppressed. A description will be given of operations to display a charging message on the electrophoretic display portion 4 after an expected lapse of time elapses since power supply is cut off as modification 3 with reference to FIGS. 12 and 13.

A description will be given of the operations to display a charging message after an expected lapse of time elapses since the power supply for the display terminal 1 is turned off in modification 3 with reference to FIG. 12. These operations are of processing that is started when the power supply for the display terminal 1 is turned off. Further, the charging message only needs to prompt the user to charge the battery and is defined beforehand. In the present modification 3, when the power supply for the display terminal 1 is turned off, a remaining battery level of the battery 2 is acquired (S51). The acquired remaining battery level is handled as a value in 10-percent units in which its first digit value is truncated, assuming the fully charged state of the battery 21 of the display terminal 1 to be 100%. Then, an expected lapse of time to elapse until the charging message is displayed is acquired based on this acquired remaining battery level from an expected time lapse table (not shown) stored in an expected time lapse table storage area (not shown) in the ROM 11 (S52). The expected time lapse table comprises the remaining battery level of the display terminal 1 and the expected lapse of time based on the remaining battery level. The remaining battery level range is subdivided into 10-percent segments including a 0-percent segment that indicates no power being left in the battery 21 through a 100-percent segment that indicates the fully charged state of the battery 21 of the display terminal 1. The expected lapse of time server as a target lapse of time to elapse until the charging message is displayed and is defined beforehand corresponding to each of the remaining battery levels.

Next, the timer counter of an expected time lapse counter is initialized to “0” and the timer start processing is started (S53). This expected time lapse counter is used to measure an expected lapse of time to elapse until the charging message is displayed. This expected time lapse counter is incremented based on the signal from the clock 15 connected to the CPU 10. Then, the standby state is entered in which the supply of power from the battery 21 to the display terminal 1 is suppressed (S54). Next, a determination is made as to whether the timer counter of the expected time lapse counter has reached the expected lapse of time (S55). Immediately after the power supply is turned off, the expected lapse of time has not elapsed (NO at S55), so that the processing returns to S55. Then, this processing is repeated until the expected lapse of time elapses. When the timer counter of the expected time lapse counter reaches at least the expected lapse of time elapses (YES at S55), the power supply for the display terminal 1 is turned on (S56). Then, the charging message is displayed on the electrophoretic display portion 4 (S57), and turn off the power supply for the display terminal 1 (S58). With this, the display terminal 1 enters the standby state. It should be noted, the message prompting charging is displayed only once. Therefore, when the power supply for the display terminal 1 is turned off after the charging message is displayed (S58), the expected time lapse counter is not started to be incremented. Further, as shown in FIG. 13, the charging message displayed on the display terminal 1 is displayed roughly at the midsection of the electrophoretic display portion 4.

In such a manner, when the power supply for the display terminal 1 is turned off, a remaining battery level of the battery 21 is acquired and, based on the acquired remaining battery level, an expected lapse of time to elapse until the display of the charging message is acquired. Then, the expected time lapse counter starts to be incremented to measure the expected lapse of time to elapse until the display of the charging message, thus turning off the power supply for the display terminal 1. This causes the display terminal 1 to enter the standby state. When the expected time lapse counter reaches at least the expected lapse of time, the power supply for the display terminal 1 is turned on, to display the charging message on the electrophoretic display portion 4 of the display terminal 1. If the charging message is displayed on the electrophoretic display portion 4, the power supply for the display terminal 1 is turned off so that the display terminal 1 enters the standby state. Since the charging message displayed on the electrophoretic display portion 4 is retained even if the power supply for the display terminal 1 is turned off, the user trying to use the display terminal 1 next time can confirm this charging message to thereby determine charging is necessary, without a need to take into account a charging date. With this, the user can charge the display terminal 1 and then use it, thus preventing a problem from occurring that the user trying to use the display terminal 1 may find that it has no sufficient power and cannot be used or it runs short of power soon after the user starts using it.

The message position displayed on the electrophoretic display portion 4 of the display terminal 1 may be better if indicated at the edge of the electrophoretic display portion 4 other than the regions where contents information such as characters, images, pictures, or a combination thereof, and menus etc. are displayed. By doing so, the information displayed on the electrophoretic display portion 4 may less covered by the charging prospective information.

Although the embodiment above and modifications 1 to 3 have employed the electrophoretic display portion 4 as the nonvolatile display device, besides the electrophoretic type one, any other nonvolatile display portion may be used as far as it is capable of keeping up the displayed contents without being supplied with power. For example, any other type of display portion may be used including a magnetophoretic type or a cholesteric LCD type. Further, the electrophoretic display portion 4 may be configured using a microcapsule.

The display terminal and the computer-readable recording medium recording a display terminal program according to the present disclosure can be applied to a display apparatus equipped with an electrophoretic type display portion.

While the invention has been described in connection with exemplary embodiments, it will be understood by those skilled in the art that other variations and modifications of the exemplary embodiments described above may be made without departing from the scope of the invention. Other embodiments will be apparent to those skilled in the art from a consideration of the specification or practice of the invention disclosed herein. It is intended that the specification and the described examples are considered merely as exemplary of the invention, with the true scope of the invention being indicated by the flowing claims.

What is claimed is:

1. A display terminal comprising:
a nonvolatile display device that retains display of information even if power supply is cut off;
a battery that supplies power to the nonvolatile display device;
a display control device that causes the nonvolatile display device to display charging prospective information serving as a prospect of charging the battery, at a predetermined timing; and
a power cutoff control device that cuts off supply of power from the battery to the nonvolatile display device while causing the nonvolatile display device to retain the display of the charging prospective information.

2. The display terminal according to claim 1, further comprising a time information acquisition device that acquires time information of a predetermined timing at which to supply power,
wherein the display control device causes the nonvolatile display device to display the time information acquired by the time information acquisition device as the charging prospective information, before supply of power from the battery is cut off.

3. The display terminal according to claim 1, further comprising:
a remaining battery level acquisition device that acquires a remaining battery level of the battery; and
a prospective time information determination device that determines as prospective time information the information serving as the prospect of a next charging time based on the remaining battery level acquired by the remaining battery level acquisition device,
wherein the display control device causes the nonvolatile display device to display the prospective time information determined by the prospective time information determination device as the charging prospective information, before supply of power from the battery is cut off.

4. The display terminal according to claim 2, further comprising:
a remaining battery level acquisition device that acquires a remaining battery level of the battery; and
a prospective time information determination device that determines as prospective time information the information serving as the prospect of a next charging time based on the remaining battery level acquired by the remaining battery level acquisition device,
wherein the display control device causes the nonvolatile display device to display the prospective time information determined by the prospective time information determination device as the charging prospective information, before supply of power from the battery is cut off.

5. The display terminal according to claim 1, further comprising an update control device that:
restarts supply of power to the nonvolatile display device after a predetermined time has elapsed since power supply was cut off by the power cutoff control device;
updates the charging prospective information displayed on the nonvolatile display device; and
cuts off supply of the power again while causing the nonvolatile display device to retain the display of the updated charging prospective information.

6. The display terminal according to claim 2, further comprising an update control device that:
restarts supply of power to the nonvolatile display device after a predetermined time has elapsed since power supply was cut off by the power cutoff control device;
updates the charging prospective information displayed on the nonvolatile display device; and
cuts off supply of the power again while causing the nonvolatile display device to retain the display of the updated charging prospective information.

7. The display terminal according to claim 3, further comprising an update control device that:
restarts supply of power to the nonvolatile display device after a predetermined time has elapsed since power supply was cut off by the power cutoff control device;
updates the charging prospective information displayed on the nonvolatile display device; and
cuts off supply of the power again while causing the nonvolatile display device to retain the display of the updated charging prospective information.

8. The display terminal according to claim 4, further comprising an update control device that:
restarts supply of power to the nonvolatile display device after a predetermined time has elapsed since power supply was cut off by the power cutoff control device;
updates the charging prospective information displayed on the nonvolatile display device; and
cuts off supply of the power again while causing the nonvolatile display device to retain the display of the updated charging prospective information.

9. The display terminal according to claim 1, further comprising:
a remaining battery level acquisition device that acquires a remaining battery level of the battery; and
a display waiting time determination device that determines a display waiting time which is awaited until the display of a charging message prompting charging based on the remaining battery level of the battery acquired by the remaining battery level acquisition device, before supply of power from the battery to the nonvolatile display device is cut off,
wherein the display control device causes the nonvolatile display device to display the charging message as the charging prospective information after the display waiting time has elapsed.

10. The display terminal according to claim 2, further comprising:
a remaining battery level acquisition device that acquires a remaining battery level of the battery; and
a display waiting time determination device that determines a display waiting time which is awaited until the display of a charging message prompting charging based on the remaining battery level of the battery acquired by the remaining battery level acquisition device, before supply of power from the battery to the nonvolatile display device is cut off,
wherein the display control device causes the nonvolatile display device to display the charging message as the charging prospective information after the display waiting time has elapsed.

11. The display terminal according to claim 2, wherein the predetermined timing is a timing when supply of power to the nonvolatile display device is cut off.

12. The display terminal according to claim 2, wherein the predetermined timing is a timing when the information displayed on the nonvolatile display device is rewritten.

13. The display terminal according to claim 1, wherein the charging prospective information displayed on the nonvolatile display device is displayed at an edge of a region in which the information can be displayed.

14. The display terminal according to claim 2, wherein the charging prospective information displayed on the nonvolatile display device is displayed at an edge of a region in which the information can be displayed.

15. The display terminal according to claim 3, wherein the charging prospective information displayed on the nonvolatile display device is displayed at an edge of a region in which the information can be displayed.

16. The display terminal according to claim 5, wherein the charging prospective information displayed on the nonvolatile display device is displayed at an edge of a region in which the information can be displayed.

17. The display terminal according to claim 9, wherein the charging prospective information displayed on the nonvolatile display device is displayed at an edge of a region in which the information can be displayed.

18. The display terminal according to claim 4, wherein the charging prospective information displayed on the nonvolatile display device is displayed at an edge of a region in which the information can be displayed.

19. The display terminal according to claim 6, wherein the charging prospective information displayed on the nonvolatile display device is displayed at an edge of a region in which the information can be displayed.

20. The display terminal according to claim 10, wherein the charging prospective information displayed on the nonvolatile display device is displayed at an edge of a region in which the information can be displayed.

21. The display terminal according to claim 11, wherein the charging prospective information displayed on the nonvolatile display device is displayed at an edge of a region in which the information can be displayed.

22. The display terminal according to claim 12, wherein the charging prospective information displayed on the nonvolatile display device is displayed at an edge of a region in which the information can be displayed.

23. The display terminal according to claim 7, wherein the charging prospective information displayed on the nonvolatile display device is displayed at an edge of a region in which the information can be displayed.

24. The display terminal according to claim 8, wherein the charging prospective information displayed on the nonvolatile display device is displayed at an edge of a region in which the information can be displayed.
